(19) United States
(12) Patent Application Publication
(10) Pub. No.: US 2016/0236782 A1
(43) Pub. Date: Aug. 18, 2016

(54) SYSTEM FOR MANAGING THE COMFORT EQUIPMENT OF AN AIRCRAFT CABIN, AIRCRAFT CABIN AND METHOD FOR IDENTIFYING AND LOCATING THE COMFORT EQUIPMENT

(71) Applicant: ZODIAC AEROTECHNICS, Plaisir (FR)

(72) Inventors: Christophe URBERO, Montigny Le Bretonneux (FR); Pascal ROUET, Bieville-Beuville (FR)

(21) Appl. No.: 15/025,963

(22) PCT Filed: Sep. 29, 2014
(86) PCT No.: PCT/FR2014/052453

§ 371 Date: Mar. 30, 2016

Related U.S. Application Data
(60) Provisional application No. 61/884,210, filed on Sep. 30, 2013.

(51) Int. Cl. B64D 11/00; B64D 11/06; H04W 4/00

(52) U.S. Cl. CPC B64D 11/0015; H04W 4/008; B64D 11/0624; B64D 11/0639; B64D 11/0626; B64D 11/06; H04W 84/12

(57) ABSTRACT

The invention concerns a system for managing the comfort equipment of an aircraft cabin, said management system comprising a calculation unit, computers (22) capable of communicating with said calculation unit to manage the comfort equipment, characterised in that it comprises near-field communication tags (32) comprising a memory (42) suitable for containing an identification of the location (ID) of the comfort equipment in the cabin, and in that the computers (22) each comprise an antenna (30) capable of reading said location identification (ID).

The present invention relates to the field of locating comfort equipment in an aircraft.

Aircraft generally comprise a system for managing the cabin environment (known as a “Cabin Management System”) capable of managing comfort equipment. This cabin management system comprises a calculation unit located in a cabin crew work area, known as a centralized calculation unit, and comfort equipment distributed throughout the aircraft cabin. An electronic board, hereinafter known as a computer, is incorporated into each item of comfort equipment. The computer of each item of comfort equipment is connected to the centralized calculation unit.

Manufacturers wish to increase the level of service offered in aircraft by proposing new services such as, for example, switching on a chosen light or set of lights from the centralized calculation unit, transmitting the cabin crew call to the centralized calculation unit or automatically turning off the cabin crew call light on the comfort equipment when the call has been received by the centralized calculation unit.

In order to perform these new services, the centralized calculation unit must be able to identify and locate the physical site of the computer of each item of comfort equipment in order to be able to manage the comfort functions locally. In addition, this identification makes it possible to locate a computer failure directly from the centralized calculation unit.

In order to be able to identify and locate each computer and thus each item of comfort equipment, certain cabin management systems make it possible to encode the address of the computer into its wiring. However, this solution requires additional wiring at cabin level as well as a connector and additional input/output resources. Thus, generally, six wires, twelve connection points and six separate inputs are added to each computer, This solution is therefore costly.

Other management systems use a code wheel incorporated in the computers. This code wheel makes it possible to program the position of the computer with a screwdriver. However, a code wheel and input/output resources must be incorporated in each computer. This solution is also costly.

In other management systems, the serial number of the computer is programmed in its memory during its production. These management systems only allow automatic identification of the computer. Creation of the link between the location of the computer and the serial number has to be done by looking for the serial number on the label of the computer and by associating this number with the location of the physical site of the computer by manual input on a control screen of the centralized calculation unit. This association requires the presence of two operators. It is lengthy and costly. Furthermore, this configuration operation must be updated each time a faulty computer must be replaced. This solution is costly in terms of labour during the first installation but also for repairs in order to reinitialize the replaced computer or computers.

Finally, in other management systems, the future location of the computer is saved in the memory thereof during its production. Then the computers are positioned in the aircraft according to the position previously saved in memory. However, in the event of replacement of a faulty computer, it is necessary to send the position of the defective computer to the factory of manufacture.

The purpose of the present invention is to propose a cabin environment management system that facilitates the replacement of a faulty computer.

To this end, the invention relates to a system for managing the comfort equipment of an aircraft cabin, said management system comprising a calculation unit, computers capable of communicating with said calculation unit for managing the comfort equipment, characterized in that it comprises near-field communication tags comprising a memory suitable for containing a location identification of the comfort equipment in the cabin, and in that the computers each comprise an antenna capable of reading said location identification.

Advantageously, the management system according to the present invention is inexpensive.

Advantageously, this invention makes it possible to manufacture and deliver computers in a standardized manner. These computers will be autoconfigured once installed in the aircraft.

According to particular embodiments, the management system comprises one or more of the following features:
said memory comprises at least one first space the access to which is protected by an encryption key, said location identification being saved in said first space.
said memory comprises at least one second area suitable for storing a WiFi network access code, said WiFi access code being specific to said item of comfort equipment, said WiFi access code being suitable for being programmed using a portable terminal equipped with a near-field interface and a dedicated application.
said location identification comprises a seat number, a row number and a column number.
the computer comprises a near-field communication memory comprising at least one first area the access to which is protected by an encryption key, said location identification being saved in said first area.
said near-field communication memory comprises a second area the access to which is open.

The invention also relates to an aircraft cabin comprising comfort equipment and a system for managing these items of comfort equipment, characterized in that said management system is according to the features mentioned above.

As a variant,
the comfort equipment comprises an item of equipment from a passenger service unit, an item of equipment for managing the seat position adjustment actuators, a display screen, an electric socket, a USB port.
near-field communication tags are bonded on a face of the overhead locker.

Finally, the invention relates to a method for identifying and locating items of comfort equipment arranged in an aircraft cabin, said identification and location method being implemented by the abovementioned management system, characterized in that it comprises the following steps:
reading said location identification system by a computer, and
transmitting said location identification to the calculation unit.

The invention will be better understood on reading the following description, given by way of example only and with reference to the figures in which:

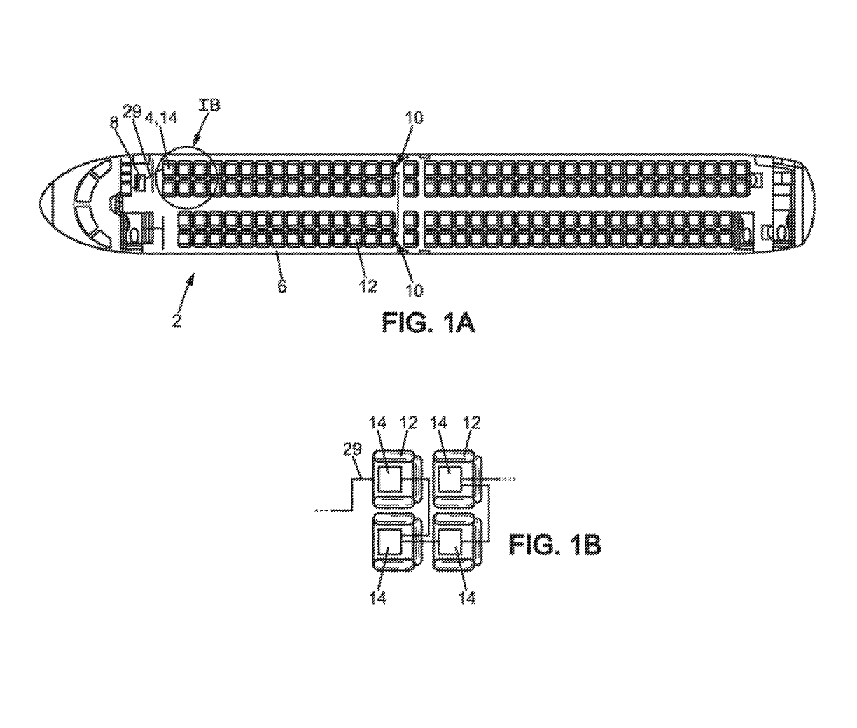

FIG. 1A is a diagrammatic cross-sectional top view of an aircraft equipped with a management system according to the invention;

FIG. 1B is an enlargement of a part of FIG. 1A.

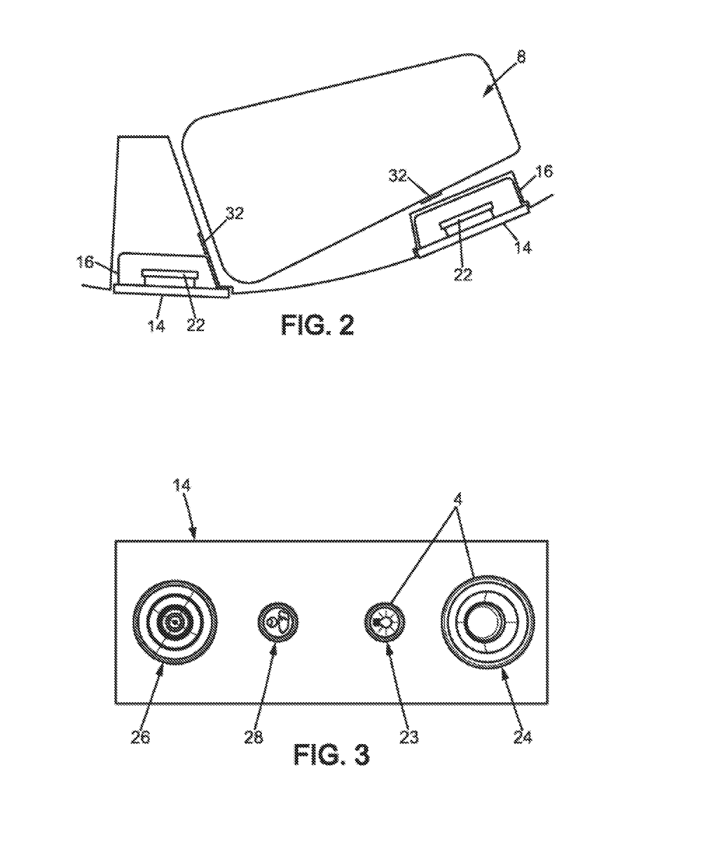

FIG. 2 is a diagrammatic cross-sectional view of the upper structure of a cabin in which passenger service units are installed;

FIG. 3 is a diagrammatic view of the front face of a passenger service unit;

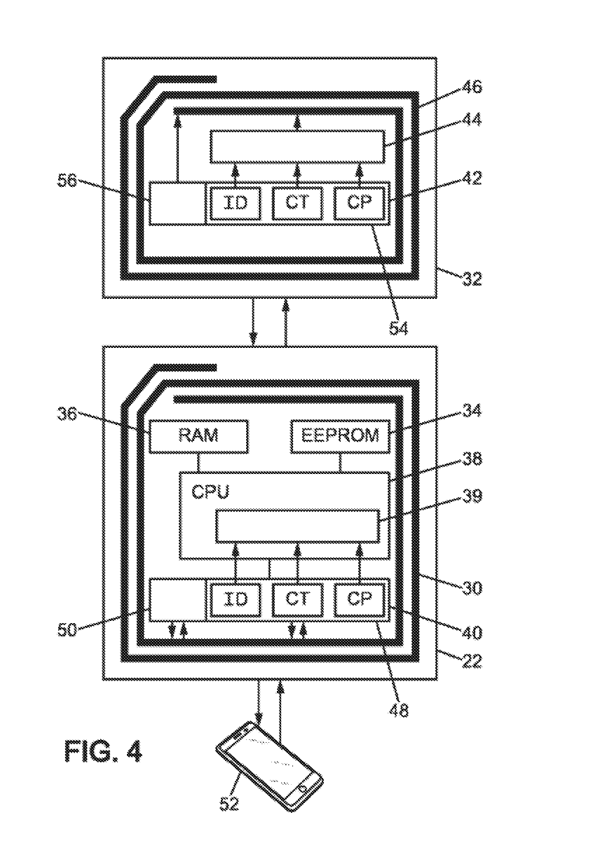

FIG. 4 is a diagrammatic view of a portable terminal and an example of the implementation of a computer and a near-field communication tag of the management system according to the invention;

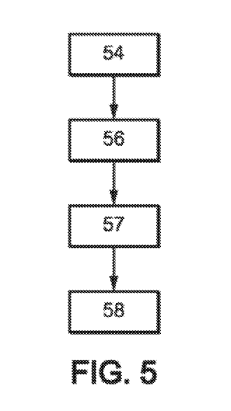

FIG. 5 is a diagram showing the steps of the identification and location method according to the invention.

In the following description, the system for managing comfort equipment according to the invention is described in its use in a regional aircraft. This system for managing comfort equipment can nevertheless be used in any aircraft.

Similarly, the present invention is described with reference to a passenger service unit. It can however be applied equally well to any other item of comfort equipment such as for example, items of equipment for managing seat position actuators, video display screens mounted in the backrest of each seat, electrical sockets or USB ports intended to supply passengers with electrical power.

The present invention relates to a management system 2 for items of comfort equipment 4 of a cabin 6 allowing the location of items of comfort equipment 4 by a remote calculation unit.

With reference to FIGS. 1A, 1B and 2, the cabin 6 of a regional aircraft comprises two columns 10 of approximately thirty-five rows of seats 12, passenger service units 14 overhanging each seat 12 and a calculation unit 8 located in a cabin crew work area.

As shown in FIG. 2, the passenger service units 14 are mounted in recesses 16 formed in the ceiling of the cabin 2 below the overhead lockers 18. They comprise items of comfort equipment 4 and an electronic board, hereinafter known as computer 22, suitable for controlling, together with the calculation unit 8, the operation of the items of comfort equipment 4.

In the embodiment shown in FIG. 3, the passenger service units 14 comprise an illuminating button 23 for switching the reading light on/off, a reading light 24, an air vent 26, and an illuminating cabin crew call button 28. As a variant, the passenger service units also comprise a loudspeaker and warning signals such as “Fasten your seat belt”, “No smoking” and “Switch off electronic devices”.

The calculation unit 8 comprises a human/machine interface. In the example shown, it is connected in series to the computers 22 by a telecommunications line 29. It is capable of communicating with the computers 22. It can comprise an application for configuring the computers.

As shown in FIG. 4, each computer 22 is equipped with an antenna 30 suitable for receiving and transmitting waves over a short distance in order to communicate with a near-field communication tag 32 arranged on the structure of the cabin 6 in line with and a few centimetres from the computer 22. In particular, in the example shown in FIG. 2, the near-field communication tags 32 are bonded on an external face of the overhead locker 18.

The calculation unit 8, the computers 22 and the near-field communication tag 32 constitute the system for managing the comfort equipment according to the invention. FIG. 4 shows an example of the implementation of a near-field communication tag 32 and a computer 22 capable of communication with a portable terminal 52 equipped with a near-field communication interface and a dedicated application (not shown).

In this example, the computer 22 comprises an electrically erasable programmable read-only memory 34 (EEPROM), a random-access memory (RAM) 36, a near-field memory 40 and a CPU processor 38 connected to the EEPROM memory, to the RAM memory and to the near-field memory 40.

The processor 38 comprises an encryption module 39.

The near-field memory 40 comprises a first area 48 connected to the encryption module 39 and a second area 50 linked to the antenna 30.

The antenna 30 is incorporated in the computer 22, i.e. the antenna is incorporated in the electronic board. When the shape of the antenna is rectangular or square, the communication distance is equal to the diagonal of the rectangle or the square. When the shape of the antenna is circular, the communication distance is equal to the diameter of the antenna.

The first area 48 contains, for example, an encryption key CP, a counter CT and an identification ID of the location of the near-field communication tag 32 inside the cabin. This location identification ID comprises, for example, the column number, the row number, as well as the number of the seat above which the near-field communication tag 32 is bonded.

The second area 50 can be directly written/read using the portable terminal 52. The portable terminal is, for example, constituted by a tablet, a mobile phone or a smartphone.

The second area 50 is capable of storing codes specific to each seat and allows a paid-for service to be accessed. Thus, an access code to the WiFi network, a code required in order to be able to display a video or a video game or a code allowing electrical power to be purchased can be stored in the second area 50.

The second area 50 can also store information of a general nature such as:
the row and seat number,
technical features relating to the aircraft,
configuration constants of the passenger service unit 14 such as the period during which the intensity of the lights is increased or reduced, the period for which the light remains on during the transition from darkness to full daylight, the period for which the light remains off during the transition from full daylight to darkness, filtering unintentional pressure on the buttons (minimum time necessary for the action to be taken into account), colour of the lighting for cabin ambiance, etc.
passenger data such as passenger meal preferences, passenger entertainment choice preferences, passenger video preferences (type of film, type of series, etc.). These data can be recorded for each flight by the companies via the calculation unit 8:
data intended for maintenance and/or for the company such as for example the number of times the seat is adjusted, the number of times the light is switched on, the number of times the crew is called, the time spent playing games, watching television. These data can for example be retrieved after each flight.
a consistency application allowing the passenger to check that they are sitting in the correct place.

The information stored in the second area 50 can be easily updated using the portable terminal 52.

The communication tag 32 comprises a factory-programmable one-time programmable memory (OTP) 42, an encryption module 44 and an antenna 46.

The read-only memory 42 comprises a first space 54 connected to the encryption module 44 and a second space 56 that is directly write/readable using the portable terminal 52.

The first space 54 comprises the same information as the first area 48 of the near-field memory 40 of the computer. In particular, the first space 54 contains an encryption key CP, a counter CT and an identification ID of the location of the near-field communication tag 32 inside the cabin. This location identification ID comprises, for example, the column number, the row number, as well as the number of the seat above which the near-field communication tag 32 is bonded.

The information contained in the first space 54 is saved in the factory during manufacture of the near-field communication tag.

During installation of the computers 22, the memories 34 of the calculators do not contain a location identity ID. They are all identical.

In contrast, the location identification ID is saved in the memory 42 of the near-field communication tag 32 during its manufacture in the factory. Then, the communication tags are bonded onto the structure of the cabin 6 at a site close to the computer 22 managing the comfort equipment 4, in a position that is not accessible to passengers.

When the calculators 22 are commissioned or when the configuration application is launched by means of the human/machine interface of the calculation unit 8, during a step 54, the computers 22 read the location identification ID saved in the near-field communication tag 32 situated close to them. Then, the computers 22 save this location identification ID in their memories 34, 36 and 40, during a step 56. During a step 57, the computers utilize an application allowing them to test their state of operation (fail or operational). Finally, during a step 58, the computers 22 transmit the location identification ID as well as their state of operation to the central unit 8, following a pre-established order.

This configuration of the computers 22 simplifies the software functions implemented in the computers 22 as well as in the calculation unit 8.

This configuration of the passenger service units 14 allows simple implementation of new services Thus, the cabin crew call is retransmitted to the human/machine interface of the calculation unit 8 situated in the cabin crew work area. The illuminating call button 28 can be switched off directly by the cabin crew from the calculation unit 8, the reading lights 23 can be switched on individually or collectively by the calculation unit 8.

When a faulty computer 22 has been replaced, either the operator restarts the configuration application, or the computer 22 automatically carries out the read operation during its commissioning. If the computer detects a difference between the identification ID saved in the memory 42 of the communication tag 32 and the identification ID contained in its own memories 34, 36 and 40, then it copies the identification ID saved in the memory 42 of the communication tag to its own memories 34, 36 and 40. Thus, repaired computers 22 can have memories 34, 36 and 40 that already contain certain information. This information will be reinitialized during the reinstallation of these computers in the cabin.

1. A system for managing the comfort equipment of an aircraft cabin, said management system comprising a calculation unit, computers suitable for communicating with said calculation unit for managing the comfort equipment, comprising near-field communication tags comprising a memory suitable for containing a location identification (ID) of the comfort equipment in the cabin, wherein the computers each comprise an antenna suitable for reading said location identification (ID).

2. The system according to claim 1, wherein the memory comprises at least one first space the access to which is protected by an encryption key (CP), said location identification (ID) being saved in said first space.

3. The system according to claim 1, wherein the memory comprises at least one second area suitable for storing a WiFi network access code; said WiFi access code being specific to said item of comfort equipment; said WiFi access code being suitable for being programmed using a portable terminal equipped with a near-field interface and a dedicated application.

4. The system according to claim 1 wherein the location identification (ID) comprises a seat number, a row number and a column number.

5. The system according to claim 1, wherein the computer comprises a near-field communication memory comprising at least one first area the access to which is protected by an encryption key (CP), said location identification (ID) being saved in said first area.

6. The system according to claim 5, wherein the near-field communication memory comprises a second area the access to which is open.

7. An aircraft cabin comprising comfort equipment and a system for managing these items of comfort equipment, wherein the management system is according to claim 1.

8. The aircraft cabin according to claim 7, wherein the items of comfort equipment comprise an item of equipment from a passenger service unit, an item of equipment for managing the seat position adjustment actuators, a display screen, an electric socket, or a USB port.

9. The aircraft cabin according to claim 7, wherein the near-field communication tags are bonded on a face of the overhead locker.

10. A method for identifying and locating items of comfort equipment arranged in an aircraft cabin; said identification and location method being implemented by a management system, produced according to claim 1, wherein the management system comprises a configuration phase of said management system, said configuration phase comprising the following steps:
reading said location identification (ID) by a computer, and
transmitting said location identification (ID) to the calculation unit.
